(19) United States
(12) Patent Application Publication
(10) Pub. No.: US 2026/0169436 A1
(43) Pub. Date: Jun. 18, 2026

(54) WATCH WITH DISPLAY LIGHTING DEVICE

(71) Applicant: The Swatch Group Research and Development Ltd., Marin (CH)

(72) Inventors: Jérôme THIAULT, Colombier (CH); Michel SAGARDOYBURU, Neuchâtel (CH)

(73) Assignee: The Swatch Group Research and Development Ltd., Marin (CH)

(21) Appl. No.: 19/366,683

(22) Filed: Oct. 23, 2025

(30) Foreign Application Priority Data
Dec. 17, 2024 (EP) 24220690.2
Dec. 20, 2024 (EP) 24222617.3

(51) Int. Cl. G04B 19/32; G04G 9/00; G04G 17/04

(52) U.S. Cl. CPC G04B 19/32; G04G 9/0041; G04G 17/04

(57) ABSTRACT

A watch including a display, a glass (6) arranged above the display and having a useful area (9) through which a user can see the display, and a lighting device including an electroluminescent unit (14a) arranged under the glass and formed by a light source, in particular an LED or OLED. The electroluminescent unit is electrically powered, from peripheral contact zones (30a to 30d) superimposed on the rim of the glass, via conductor pads (22g to 22j), made of transparent conductor material, that cover all of the useful area except for interstices (26a to 26d) separating the conductor plates, at least in the useful area. Each interstice separates two adjacent conductor areas and has a width, in particular less than 100 µm and preferably less than 50 µm, that makes this interstice imperceptible at a distance of approximately 30 cm, in normal ambient light, for a user.

### CROSS REFERENCE TO RELATED APPLICATIONS

This application claims priority to European Patent Application Nos. 24220690.2, filed on December 17, 2024 and 24222617.3 filed on Dec. 20, 2024, the entire contents of which are incorporated herein by reference.

### TECHNICAL FIELD OF THE INVENTION

The present invention relates to the field of watches with an analogue or digital display, generally at least of the current time, and a lighting device for this display. More specifically, the invention relates to an active lighting device, in other words, a device comprising at least one light source powered, in particular using a control, by a source of electrical energy.

### Technological Background

Several active lighting devices (“active” as opposed to passive lighting devices, in particular the arrangement of phosphorescent materials on the dial and/or hands) have already been proposed to enable an analogue display to be read in a dark or black environment (that is, a space not illuminated by an external light source).

In particular, document WO 02/23637 describes a watch with an analogue display and an electroluminescent diode (also referred to as an “LED” from the acronym for “Light Emitting Diode”) arranged in the centre of the lower surface of the watch glass. The LED is electrically powered from the periphery of the glass by two straight tracks made of a transparent conductor material, made of Indium Tin Oxide (a mixture of indium oxide and tin oxide, also referred to as ITO). The advantages of such a lighting device are that the electroluminescent diode can have small dimensions, making its presence unobtrusive or even almost imperceptible to a user, particularly when it is aligned with the axis of a hand on the analogue display. However, the lighting device described in the aforementioned document has two drawbacks. Firstly, the distance between the periphery of the glass and the centre of the glass is relatively long. The two straight conductor tracks are therefore narrow and have a fairly high resistance, which limits the value of the electrical current that can be supplied to the LED and, accordingly, the amount of light it can emit at a given power voltage. Secondly, although the ITO tracks have good transparency, they remain visible when the glass is darkened slightly. A user can distinguish them under certain lighting conditions, which is not aesthetically pleasing and could even imply that the glass has a manufacturing problem.

### Summary of the Invention

The invention aims to remedy the two problems encountered in the prior art as described above in the technological background.

To this end, the invention relates to a watch comprising a display, a glass arranged above the display and having a useful area through which a user of the watch can see the display, and a lighting device comprising at least one electroluminescent unit arranged under the glass and above the display, this electroluminescent unit being formed from at least one light source, in particular an LED or OLED (acronym for “Organic Light Emitting Diode”). Said at least one electroluminescent unit is electrically powered from peripheral contact zones located in axial superposition outside said useful area, via conductor pads, made of transparent conductor material, that cover at least the entire lower part of the useful area of the glass except for an interstice separating the two conductor pads in the case of a single electroluminescent unit with only two power supply contacts, or interstices separating said conductor pads, in the case of an electroluminescent unit with at least three power supply contacts or of a plurality of electroluminescent units. A remarkable feature is that each interstice separates two adjacent conductor pads and has a width such that this interstice is almost imperceptible or preferably imperceptible, in normal ambient light, to a user of the watch with normal eyesight, the width of said interstice, respectively of said interstices, being less than two hundred micrometres (200 µm).

In a preferred embodiment relating to the case of an electroluminescent unit with at least three power supply contacts or of a plurality of electroluminescent units, the individual conductor pads, which are each electrically connected to a single power supply contact associated with a single light source, are configured such that they each have substantially the same electrical resistance between respective peripheral contact zones and respective power supply contacts on the electroluminescent unit or on the plurality of electroluminescent units.

In a particular variant, a conductor pad common to a plurality of said power supply contacts is configured so as to have a lower electrical resistance than said individual conductor pads.

### BRIEF DESCRIPTION OF THE FIGURES

The invention will be described in greater detail below with reference to the appended drawings, which are given by way of non-limiting examples, in which:

FIG. 1 is a schematic cross-section of a watch according to a first embodiment of the invention;

FIG. 2 is a planar view of a first variant of the first embodiment, showing the part of the lighting device that is arranged under the watch glass;

FIG. 3A is a planar view of a second variant of the first embodiment, showing the part of the lighting device that is arranged under the watch glass;

FIG. 3B is a planar view of a third variant of the first embodiment, showing the part of the lighting device that is arranged under the watch glass;

FIG. 4 is a schematic cross-section of a watch according to a second embodiment of the invention;

FIG. 5 is a planar view of a first variant of the second embodiment, showing the part of the lighting device that is arranged under the watch glass; and

FIG. 6 is a planar view of a second variant of the second embodiment, showing the part of the lighting device that is arranged under the watch glass.

### DETAILED DESCRIPTION OF THE INVENTION

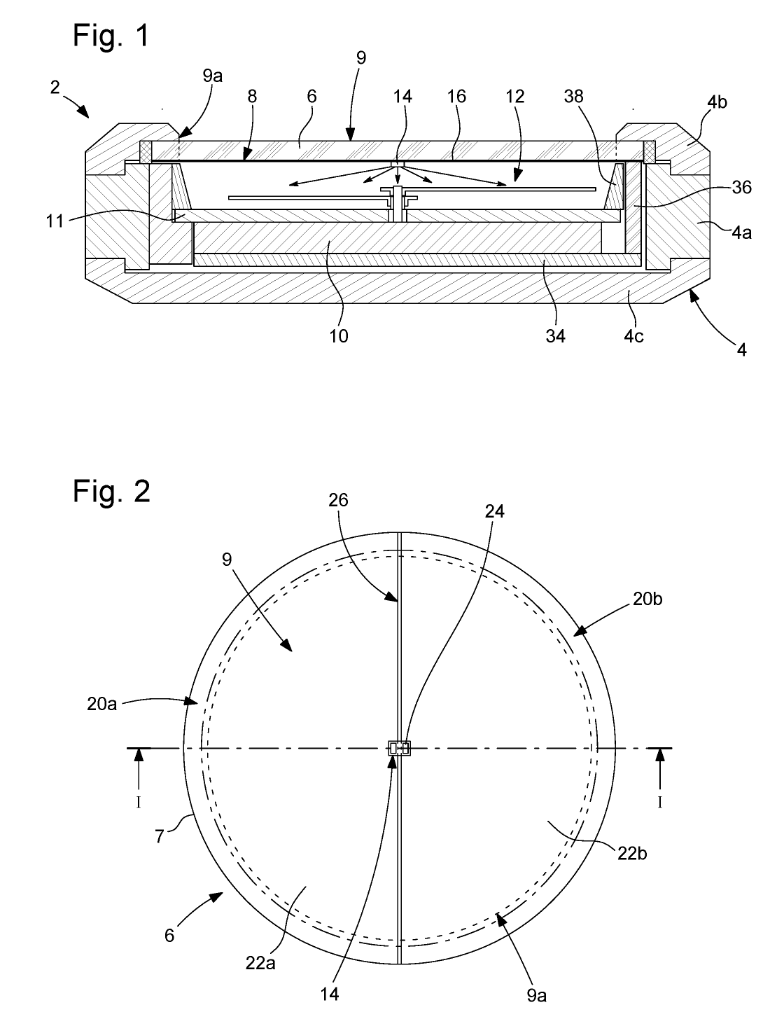

With reference to FIGS. 1-3B, a first embodiment of a watch according to the invention will be described below.

In general terms, the watch 2 comprises a case 4, a movement 10, an analogue display 12, a glass 6 arranged above the analogue display and a lighting device. The lighting device comprises at least one electroluminescent unit, such as an LED or OLED, that is arranged under the glass and above the analogue display. The glass 6 has a useful area 9, superimposed inside an upper opening 9a of the case 4, through which a user of the watch can view the analogue display 12. In particular, the case 4 is formed by a middle 4a, a bezel 4b and a back 4c. The analogue display 12 comprises a set of hands and a dial 11.

In a first variant shown in FIG. 2, the electroluminescent unit is an LED 14 arranged on a structured layer of conductor material 16, which is deposited on the lower surface 8 of the glass 6 and covers almost the entire useful area 9 of the glass in the case for a user of the watch. In the variant shown, the conductor layer 16 covers almost the entire lower surface 8 of the glass. The conductor layer 16 is structured so as to form conductor pads for powering the LED 14 or, in other variants which will be described below, the LEDs or OLEDs provided. More specifically, the LED 14 is electrically powered via two power supply contacts 24, which are arranged on the LED on the same side as the conductor layer 16, from two peripheral contact zones 20a and 20b located in axial superposition outside said useful area 9, that is, along the perimeter 7 of this glass, via two conductor pads 22a and 22b, made of transparent conductor material, that cover at least the entire lower part of the useful area 9 of the glass 6 except for an interstice 26 separating the only two conductor pads 22a and 22b. These only two conductor pads (which can also be referred to as “electrodes”) each extend over almost half of the useful area 9.

There are currently electroluminescent sources with very small dimensions, mini-sources, which can be almost imperceptible or even imperceptible to the naked eye. These mini light sources are very small (< 500 µm). Two main types are well known, LEDs and OLEDs, the latter of which can be very small and produced directly on a transparent substrate. The LED 14 is generally less than a millimetre in size and advantageously less than 500 µm on each side so that the LED is not easily visible when it is switched off. In a particular variant, a mini-LED with dimensions of 150 x 100 μm² has been chosen, meaning with a side of less than 200 µm, which is virtually imperceptible at around 30 cm to a user with normal eyesight. A mini-LED substantially equal to or smaller than 100 x 100 μm² in size is preferred, such a mini-LED being imperceptible at around 30 cm to a user of the watch with normal eyesight, in other words invisible to the naked eye. The mini-LED can be blue, green, yellow or red, but also white. To produce a white LED, a phosphorescent material can be deposited on a blue LED to convert blue light into yellow light. The blend of residual blue light from the LED with the yellow light generated by the phosphorescent material is perceived by the eye as white light.

Advantageously, the transparent conductor pads 22a and 22b are structured by photolithography of a thin transparent conductor layer 16, made of transparent conductor oxide or by printing silver nanostructures. By way of common example, the transparent conductor oxide is Indium Tin Oxide (ITO) or Indium Zinc Oxide (referred to as IZO from the acronym for “Indium Zinc Oxide”). Other techniques for forming transparent conductor pads and other transparent conductor materials can be considered by a person skilled in the art.

The electrical connection between the power supply contacts 24 on the LED 14 and the transparent conductor pads 22a and 22b can be made in various ways. By way of example, an isotropic or anisotropic conductor glue or a eutectic solder can be used. In the case of an isotropic conductor glue, in particular one based on silver particles, two separate, very small beads of glue each ensure the adhesion of the LED to the substrate and the electrical conductivity between the surfaces/contact pads or contact studs, referred to as the power supply contacts, on the LED and the transparent conductor pads 22a and 22b. In the case of an anisotropic conductor glue, in particular made with gold microbeads, a single extended surface of glue under the LED 14 ensures the adhesion of the LED to the substrate and electrical conductivity only along the axis orthogonal to the lower surface 8 on the glass 6 between the power supply contacts 24 on the LED and the transparent conductor pads 22a, 22b. It should be noted that in the figures, the power supply contacts 24 are schematically drawn as a continuous line so that they are clearly visible and easily recognisable, whereas they are located under the LED substrate and are therefore concealed by this substrate in the views from the underside in the various figures shown in planar view.

In the case of eutectic soldering, that is, soldering an alloy with a low melting point, the power supply contacts 24 on the LED are previously covered with an alloy layer, in particular made of Au/Sn, and the relative zones on the conductor layer (substrate) are covered with a metallic layer, in particular made of gold (Au). During the soldering process, the LED contacts are rubbed and heated on the substrate so that the contact surface melts. After cooling, the LED is firmly soldered to the substrate and forms a good contact with low electrical resistance. This process results in lower contact resistance and higher bond strength compared to a conductor glue, but requires greater surface preparation of the LED contacts and the substrate beforehand.

In FIG. 2, the two peripheral contact zones 20a and 20b radially extend the two conductor pads 22a and 22b. They are made from the same transparent conductor material as the conductor pads, by structuring the conductor layer 16, and they are also separated from each other by the interstice 26. In fact, nothing differentiates the two peripheral contact zones from the two conductor pads apart from the fact that the peripheral contact zones are located, in axial superposition, outside the useful area 9 of the glass 6, outside the opening 9a in the plane of the glass, and run along the periphery 7 of the glass, such that the electrical connector 36 between the electrical power supply circuit 34 and the peripheral contact zones 20a and 20b is not visible to a user of the watch 2.

It will be noted that, although the ITO or IZO conductor pads are transparent, they are slightly coloured and change the reflection of light on the lower surface 8 on the glass 6, in particular if it is made of sapphire, relative to a part of this lower surface that does not have such a conductor layer, such that the eye can distinguish a zone in the glass 6 that has a part with this conductor layer from a part that does not. Moreover, there is a slight difference in height at the edge of each conductor pad, making fine lines visible to a user of the watch. According to the invention, in general, the width of the interstice 26 is such that this interstice is advantageously almost imperceptible or preferably imperceptible at approximately 30 cm, in normal ambient light, for a user of the watch with normal eyesight. One advantage of having more extensive contact areas is that the conductor pad is thinner than in the case of conductor tracks, which are by definition narrow, while maintaining good electrical conductivity, even better than in such conductor tracks. A thinner conductor layer for the conductor pads means better transparency and also less visibility of the rims on the conductor pads.

‘Interstice’ is understood to mean a small space or slit between two material zones and separating these two material zones. To make the contrast between the conductor pads and the substrate, namely, the glass 6, as inconspicuous as possible, the interstice 26 (in other words, the space/slit) between the two conductor pads is preferably as narrow as possible while ensuring electrical insulation between these conductor pads. For example, by structuring an ITO layer using photolithography, a very narrow interstice, of around 10 μm, can be formed between the two conductor pads.

In general, the width of the interstice is less than two hundred micrometres (200 µm). In an advantageous variant, said width is less than one hundred micrometres (100 µm). In a preferred variant, said width is less than fifty micrometres (50 μm).

The transparent conductor pads 22a, 22b are connected to the electrical power supply circuit 34 by at least one connector. In the variant in FIG. 2, a cylindrical spring-loaded connector 36 is shown that enables a single transparent conductor pad to be connected to the electrical power supply circuit. In the first variant, two connectors 36 are provided, one for each of the two transparent conductor pads. In an alternative variant, the electrical connection is made by an anisotropic elastomer conductor (Zebra^{®}) arranged in one of the two peripheral zones through which the interstice 26 runs. To ensure that the electrical connection means between the electrical power supply circuit 34 and the peripheral contact zones 20a and 20b are not visible to a user of the watch, the connectors 36 are arranged behind a flange 38 forming the display space of the watch 2.

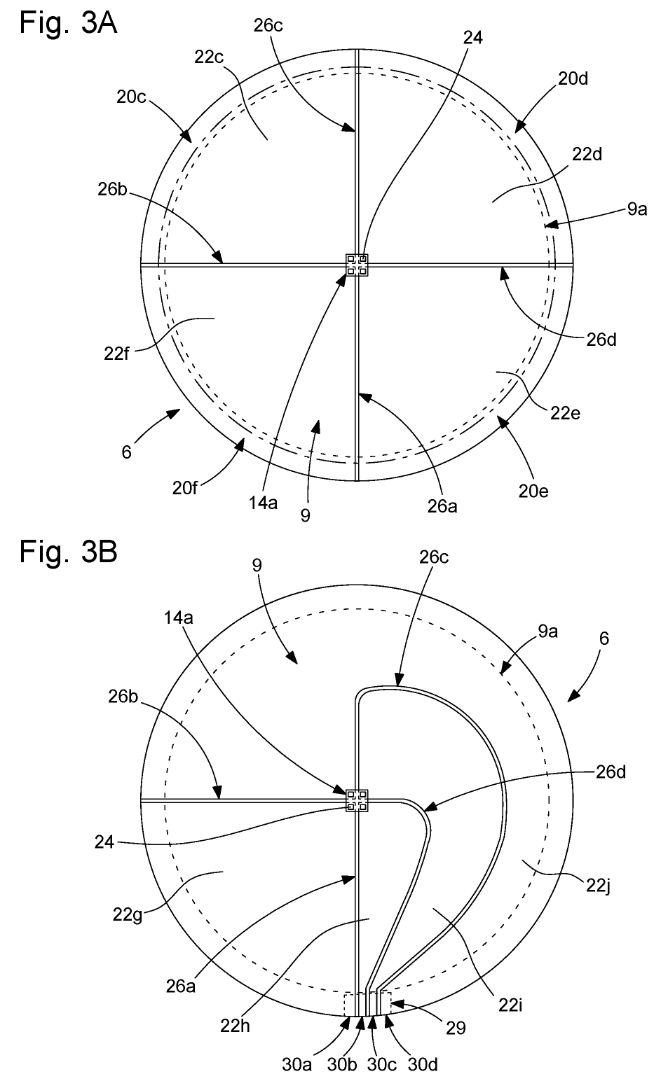

In FIGS. 3A and 3B, a second variant and a third variant are shown. In these two variants, the electroluminescent unit 14a is formed by three LEDs arranged on the same support and having a common anode or cathode and each an individual cathode or anode, such that the electroluminescent unit 14a has four power supply contacts 24. This electroluminescent unit 14a is designed to provide white light via three LEDs (mini-LEDs) respectively producing red, green and blue light. In another variant, two LEDs can be provided, one emitting blue light and the other yellow light. By supplying power separately to the three LEDs, the colour of the lighting can be adjusted on demand to obtain a certain white light.

In FIG. 3A, the unit 14a is electrically powered, from four peripheral contact zones 20c-20f located on the rim of the glass 6, via four conductor pads 22c-22f, made of transparent conductor material, covering the entire useful area 9 of the glass in the watch, except for four interstices 26b-26d that separate the conductor pads in pairs, meaning that each one separates two adjacent conductor pads. Here again, the width of each interstice is such that it is virtually imperceptible, and preferably imperceptible to a user of the watch at a distance of approximately 30 cm in normal ambient light. The various advantageous width ranges given above also apply to all other variants. In this second variant, each transparent conductor pad extends substantially over a quarter of the lower surface of the glass, this variant being advantageous if only one of the LEDs is activated at any one time. There are accordingly four identical conductor pads 22c-22f. The peripheral contact zones 20c-20f extending the conductor pads are spaced along the periphery of the glass. This results in a certain drawback for the means of electrical connection to the electrical power circuit, which must be located along the rim of the glass over an angular distance greater than 180°, and consequently for the electrical connector to the electrical power circuit. In particular, four cylindrical spring-loaded connectors 36 can be provided, spaced along the rim of the glass or arranged in pairs on either side of an interstice, or two diametrically opposite anisotropic elastomer conductors each covering an interstice, namely interstices 26a and 26c or interstices 26b and 26d.

The third variant, shown in FIG. 3B, makes it possible to remedy the aforementioned drawback of the second variant. The peripheral contact zones 30a-30d on the conductor pads 22g-22j are arranged side by side in the same localised connection sector 29, which in this example extends over less than one-eighth of the periphery 7 of the glass, with the peripheral contact zones arranged in a row. In a general variant, the connection sector extends over less than one-eighth of the circumference 7. To achieve homogeneity of the light emitted between the LEDs and maximum overall power, the pattern for structuring the conductor pad 16 is made such that the individual electrodes/individual conductor pads, which are each electrically connected to a single power supply contact 24 specific to a single LED, each have substantially the same electrical resistance between the power supply contacts and respective peripheral contact zones. In FIG. 3B, the individual conductor pads are referenced 22h-22j. The common conductor pad 22g, connected to a power supply contact 24 on the electroluminescent unit 14a common to the three LEDs, is configured such that it has a lower electrical resistance than the individual conductor pads, each of which is associated with a single LED. In the second variant, as shown in FIG. 3A, all of the conductor pads are similar and have the same electrical resistance. It should be noted that in the second variant, the common conductor pad can also have a lower electrical resistance, for example by structuring the conductor layer 16 so that the common conductor pad extends over a greater angular distance, in particular 150°, and the three individual conductor pads extend over the same smaller angular distance, namely 70°.

The light source, although arranged to emit towards the dial 11, also emits partially in an outward direction, which can be unsightly and also dazzle the wearer of the watch. In fact, this direct upward emission is generally more intense than the light reflected by the dial and interferes with the legibility of the display. One solution is to add an opaque and optionally reflective cover between the outside of the glass and the electroluminescent unit, in particular the LED.

To use a cover to block the light emitted by the electroluminescent unit towards the user, several configurations can be considered. Advantageously, the cover is made on the side of the lower surface 8 of the glass, directly on this lower surface or between the transparent conductor layer 16 and the electroluminescent unit/LED. In the latter case, the cover must guarantee both the desired optical opacity and the electrical conductivity to power the electroluminescent unit/LED. The following two embodiments are possible:

The cover is made from a structured black resin that comprises openings filled with a conductor material enabling electrical contact to be made between the transparent electrodes and the power supply contacts on the electroluminescent unit.

The cover is made from an opaque anisotropic conductor glue, which is used to attach and electrically connect the electroluminescent unit, this glue comprising, for example, conductive metal beads incorporated in a resin rendered optically opaque by the addition of non-conductive absorbent pigments.

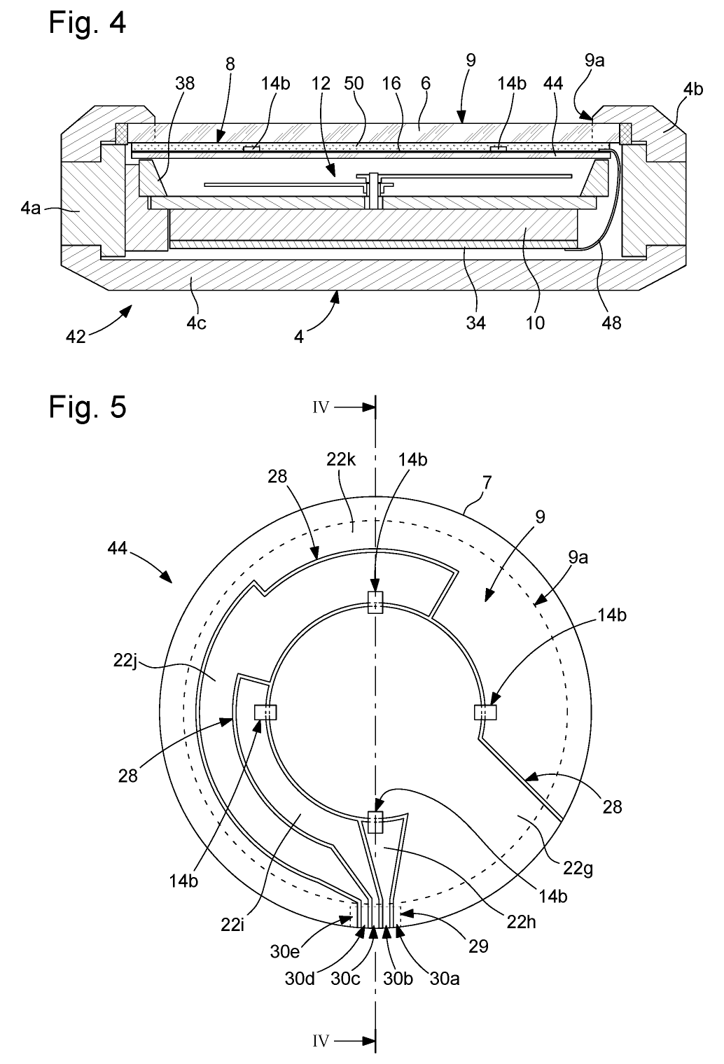

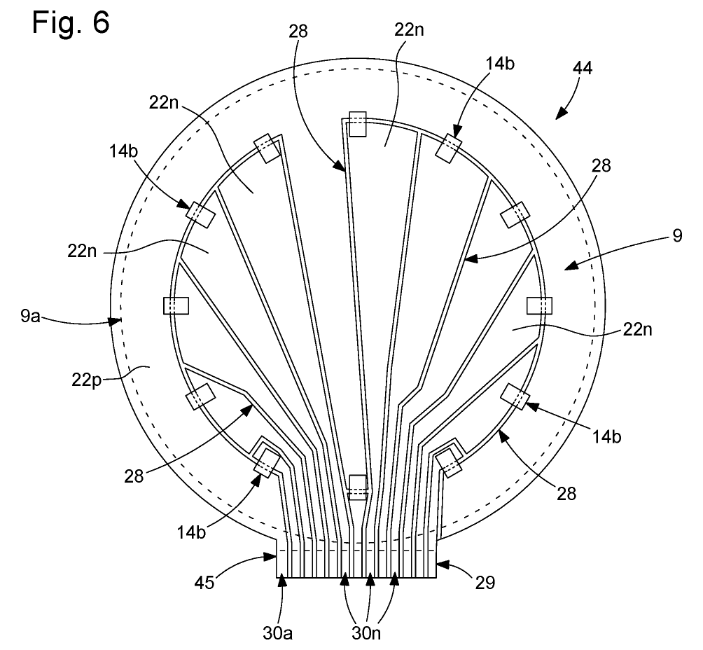

A second embodiment will be described below with reference to FIGS. 4-6. Similar elements in the first embodiment and references already described will not be described again here in detail. FIGS. 5 and 6 respectively show a planar view of a first variant and of a second variant of part of the lighting device, according to the second embodiment of the invention, that is arranged under the glass of the watch.

This second embodiment differs from the first embodiment essentially in two particular characteristics. Firstly, several electroluminescent units 14b, spaced apart from each other, are arranged under the glass 6 in the useful area 9 formed by the opening 9a of the bezel 4b on the case 4. Secondly, the electroluminescent units 14b are arranged on a transparent substrate 44, which is separate from the watch glass and glued underneath it with a layer of transparent glue 50. Advantageously, OLED technology is used to make the electroluminescent units / light sources 14b, each of which has a micrometre-sized emitting surface that is not perceptible to the naked eye at around 30 cm. Preferably, when seen in a planar view, each OLED 14b has a surface area substantially equal to or less than 100 x 100 µm². The transparent substrate 44 can be made of glass, sapphire, PC, PMMA or other transparent polymers. It should be noted that, in another variant, the light sources are placed under the transparent substrate 44, on the side of the analogue display 12.

Unlike LEDs, which are generally produced in a preliminary step and then brought in and attached to the glass 6 or to the additional transparent substrate 44 (variant considered), OLEDs are produced directly on the lower surface 8 of the glass 6 (variant considered) or on the additional transparent substrate 44, which covers the entire useful area 9 of the glass, as shown in FIG. 4. In the case of OLEDs, the light-emitting surfaces are obtained by structuring the functional layers that form each OLED (anode, organic layers, cathode). In a first step, the transparent conductor pads 22g (common conductor pad) and 22h-22k (individual conductor pads) in the first variant, respectively 22p (common conductor pad) and 22n (individual conductor pads) in the second variant, are deposited on the transparent substrate 44. In a second step, the anodes on the OLEDs 14b are made on respective contact zones on the individual conductor pads 22h-22k. In a third step, the organic layers are deposited on the anodes and, in a fourth step, the cathodes are deposited on the organic layers with a part of each extending beyond the respective organic layers and covering a contact zone on the common conductor pad 22g. Lastly, a protective layer, for example made of glass, covers the OLEDs as is conventionally the case.

According to the invention, as in the first embodiment, the electroluminescent units 14b are electrically powered from peripheral contact zones 30a-30e in the first variant, respectively 30a and 30n in the second variant, via the conductor pads 22g-22k, respectively 22p and 22n, which are made of transparent conductor material on the transparent substrate 44. The peripheral contact zones 30a-30e, respectively 30a and 30n, are arranged side by side, preferably in a row, in the same connection sector 29 located on the rim of the transparent substrate 44, outside the useful area of the glass 6 in axial projection, and located in a restricted angular sector. The conductor pads cover at least the entire lower part of the useful area 9 of the glass 6, except for interstices 28 separating these conductor pads. Each interstice separates two adjacent conductor pads and has a width such that this interstice 28 is imperceptible, in normal ambient light, to a user of the watch observing the display. The advantageous range of values and the preferred range of values indicated above for the width of the interstices also apply to the second embodiment.

Preferably, to achieve luminous homogeneity between the light sources, namely the OLEDs 14b, and maximum overall lighting power, the transparent conductor pads in the conductor layer 16, which covers the transparent substrate 44, are structured to achieve low electrical resistances, which are substantially equal for the individual conductor pads, between the peripheral contact areas and the respective power supply contacts on the OLEDs 14b. This is made possible by the fact that the transparent conductor pads extend overall at least over a complete surface area formed by the useful area 9 of the glass 6, except for the interstices 28. Moreover, as already indicated, this advantageous characteristic makes it possible to conceal the presence of the conductor electrodes that extend facing the lower surface 8 of the glass, in axial projection at least in the useful area 9, given that the interstices are very narrow and almost imperceptible, preferably completely imperceptible to the naked eye. This makes the lighting device according to the invention very discreet. It should be noted that the expression “useful area of the glass” is to be understood as meaning a cylindrical space with an axial direction and an outer periphery formed by the opening 9a of the bezel 4b on the case 4.

The common conductor pad 22g, respectively 22p, connected to a plurality of respective power supply contacts on the OLEDs, is configured so as to have a lower electrical resistance than the individual conductor pads 22h-22k, respectively 22n between these power supply contacts and the peripheral contact zone 30a, because this common conductor pad has a higher electrical current flowing through it since it collects several electrical currents from the individual conductor pads.

The cathodes are preferably made of an opaque material that keeps the OLEDs from emitting axially through the glass 6. Advantageously, the cathodes are reflective. It is important that the cathodes each cover a very small area of the common conductor pad beyond the organic layers, so as not to be visible. To keep the size of the cathodes to a minimum, the contact zones on the common conductor pad 22g are located as close as possible to the light-emitting zones on the OLEDs, at the periphery of the light-generating organic layers. As in the first embodiment, an opaque and optionally reflective cover can also be provided above each OLED, these covers being, for example, deposited on the lower surface 8 of the glass, facing the OLEDs. When assembling the glass 6 with the transparent substrate 44 using the glue 50, care must be taken to align the covers quasi point-wise with the OLEDs, alternatively with the LEDs in another version using LEDs instead of OLEDs.

The electrical connection between the peripheral contact zones, preferably aligned one after the other in a straight row, and the electrical power supply circuit 34 is made using a flexible circuit board 48.

In the first variant (FIG. 5), the lighting device comprises four light sources 14b (electroluminescent units each formed by a single OLED or LED) angularly arranged at regular intervals, with two adjacent light sources having an angular distance between them equal to 90°. The common conductor pad 22g occupies a central zone on the transparent substrate 44 and a connector zone from this central zone to the peripheral contact zone 30a, while the individual conductor pads extend around the central zone. In the second variant (FIG. 6), the lighting device comprises twelve light sources 14b, each light source being provided above a different number indicating the hours one to twelve on the dial. The common conductor pad 22p occupies a peripheral zone on the transparent substrate 44 and a substantially diametral inner zone, while the individual conductor pads 22n fan out from the contact zones 30n. In this second variant with a relatively large number of separate light sources 14b, the transparent substrate 44 comprises an outer protruding part 45 on which the connection sector 29 is located.

The lighting device according to the invention can also be used as a “frontlight” system in the case of a watch with a digital display (also referred to as an “electronic display”) that is purely reflective, thus making it possible to read the information when there is a lack of light on such a digital display. This type of digital/electronic display in a watch, in particular a highly energy-efficient LCD display, provides better contrast and better legibility during the day than a similar digital display equipped with a backlight system, because in the latter case the digital display has to be transflective to allow the backlight to reach the observer, and therefore has poorer optical quality during the day. The present invention is particularly suitable for a digital display overlaid with a structure, in particular a decorative structure, forming various display zones with a lighting device comprising a plurality of LEDs or OLEDs arranged in front of these display zones so as to light these zones locally, simultaneously or selectively.

1. A watch comprising a display, a glass arranged above the display and having a useful area through which a user of the watch can see the display, and a lighting device comprising at least one electroluminescent unit arranged under the glass and above the display, this electroluminescent unit being formed by at least one light source, in particular an LED or OLED; wherein said at least one electroluminescent unit is electrically powered from peripheral contact zones located in axial superposition outside the useful area, via conductor pads, made of transparent conductor material, that cover at least the entire lower part of the useful area of the glass except for an interstice separating the two conductor pads, in the case of a single electroluminescent unit with only two power supply contacts, or interstices separating said conductor pads, in the case of an electroluminescent unit with at least three power supply contacts or of a plurality of electroluminescent units; and wherein each interstice separates two adjacent conductor pads and has a width that is less than or substantially equal to 200 µm.

2. The watch according to claim 1, wherein said width is less than 100 µm.

3. The watch according to claim 1, wherein said width is less than 50 µm.

4. The watch according to claim 1, wherein, in said case of a single electroluminescent unit with only two power supply contacts, the two conductor pads each extend over almost half the useful area of the glass.

5. The watch according to claim 1, wherein, in the case of an electroluminescent unit with at least three power supply contacts or of a plurality of electroluminescent units, individual conductor pads among said conductor pads are configured so as to each have substantially the same electrical resistance between said respective peripheral contact zones and the respective power supply contacts on the electroluminescent unit or on the plurality of electroluminescent units, the individual conductor pads each being electrically connected to a single power supply contact associated with a single light source.

6. The watch according to claim 5, wherein a common conductor pad is configured so as to have a lower electrical resistance than said individual conductor pads, the common conductor pad being connected to a plurality of said power supply contacts and/or being associated with a plurality of light sources connected to the same power supply contact.

7. The watch according to claim 5, wherein the peripheral contact zones are spaced along the periphery of the glass.

8. The watch according to claim 5, wherein the peripheral contact zones are arranged in a single connection sector that extends over less than a quarter of the periphery, preferably over less than an eighth of the periphery with the peripheral contact zones arranged in a row.

9. The watch according to claim 1, wherein said conductor pads are formed by a structured conductor layer that is deposited on the lower surface of the glass; and wherein said at least one electroluminescent unit is attached to said conductor pads.

10. The watch according to claim 1, wherein said conductor pads are formed by a structured conductor layer that is deposited on the upper surface of a transparent substrate, said at least one electroluminescent unit being attached to said conductor pads; and wherein the transparent substrate is glued to the lower surface of the glass and coats said at least one electroluminescent unit.
